(19) United States
(12) Patent Application Publication
(10) Pub. No.: US 2024/0045701 A1
(43) Pub. Date: Feb. 8, 2024

(54) METHOD, DEVICE AND SYSTEM FOR LOADING PAGE DATA

(71) Applicant: BOE Technology Group Co., Ltd., Beijing (CN)

(72) Inventor: Yingjie LI, Beijing (CN)

(21) Appl. No.: 17/640,644

(22) PCT Filed: Apr. 20, 2021
(86) PCT No.: PCT/CN2021/088450

§ 371 Date: Mar. 4, 2022

(30) Foreign Application Priority Data
May 19, 2020 (CN) 202010424439.2

(51) Int. Cl. G06F 9/451; G06F 16/953; G06F 16/957; G06F 40/221

(52) U.S. Cl. CPC G06F 9/451; G06F 16/953; G06F 16/9574; G06F 40/221

(57) ABSTRACT

The present disclosure provides a method, a device and system for loading page data. The method includes: determining a target page to be displayed; transmitting request information for requesting a data packet corresponding to the target page to a server, the request information including an identifier of the target page and a first identifier set, the first identifier set including identifiers of pages loaded by the UE in a second identifier set, and the second identifier set including identifiers of all pages in a software package to which the target page belongs; and receiving the data packet corresponding to the target page from the server.

### CROSS-REFERENCE TO RELATED APPLICATION

This application claims a priority of the Chinese Patent Application No. 202010424439.2 filed on May 19, 2020, which is incorporated herein by reference in its entirety.

### TECHNICAL FIELD

The present disclosure relates to the field of communication technology, in particular to a method, a device and a system for loading page data.

### BACKGROUND

With the development of intelligent devices and mobile Internet, the quantity of software developed for a User Equipment (UE) is increasing, and the functions of the software are becoming more and more diversified for more and more application scenarios.

After the software has been downloaded and installed by the UE, a software developer also needs to update the software such as bug fixes and function expansion. Hence, usually a version of the software needs to be updated. In a conventional software update method, after the release of a new version of the software, a user needs to download and install the new version, which is time-consuming and complicated. When the software is updated frequently, the user experience may be adversely affected.

### SUMMARY

In a first aspect, the present disclosure provides in some embodiments a method for loading page data for a UE, including: determining a target page to be displayed; transmitting request information for requesting a data packet corresponding to the target page to a server, the request information including an identifier of the target page and a first identifier set, the first identifier set including identifiers of pages loaded by the UE in a second identifier set, and the second identifier set including identifiers of all pages in a software package to which the target page belongs; and receiving the data packet corresponding to the target page from the server.

In a possible embodiment of the present disclosure, subsequent to determining the target page to be displayed and prior to transmitting the request information for requesting the data packet corresponding to the target page to the server, the method further includes: searching whether the data packet corresponding to the target page is stored in a local cache; if so, reading the data packet corresponding to the target page from the local cache; and if not, transmitting the request information to the server.

In a possible embodiment of the present disclosure, the request information further includes screen information about the UE, and the screen information about the UE includes one or more of a screen size of the UE, a screen resolution of the UE and the quantity of pixels in a unit area of a screen of the UE.

In a possible embodiment of the present disclosure, the method further includes displaying the target page in accordance with the data packet corresponding to the target page.

In a possible embodiment of the present disclosure, prior to displaying the target page in accordance with the data packet corresponding to the target page, the method further includes: verifying whether the data packet corresponding to the target page is legal; and displaying the target page in accordance with the data packet corresponding to the target page in the case that the data packet corresponding to the target page is legal.

In a possible embodiment of the present disclosure, the determining the target page to be displayed includes: receiving a keyword inputted by a user; transmitting the keyword to the server; receiving at least one page identifier from the server; displaying the at least one page identifier; receiving an input of a target page identifier in the at least one page identifier from a user; and determining a page corresponding to the target page identifier as the target page.

In a second aspect, the present disclosure provides in some embodiments a method for loading page data for a server, including: receiving request information for requesting a data packet corresponding to a target page from a UE, the request information including an identifier of the target page and a first identifier set, the first identifier set including identifiers of pages loaded by the UE in a second identifier set, and the second identifier set including identifiers of all pages in a software package to which the target page belongs; determining data required to display the target page; obtaining data loaded by the UE in accordance with the first identifier set; determining incremental data in accordance with the data required to display the target page and the data loaded by the UE; generating the data packet corresponding to the target page in accordance with the incremental data; and transmitting the data packet corresponding to the target page to the UE.

In a possible embodiment of the present disclosure, the request information further includes screen information about the UE; and the screen information about the UE includes one or more of a screen size of the UE, a screen resolution of the UE and the quantity of pixels in a unit area of a screen of the UE. The generating the data packet corresponding to the target page in accordance with the incremental data includes: extracting data corresponding to the screen information from an incremental class and an incremental resource; and packaging the data corresponding to the screen information into the data packet corresponding to the target page.

In a possible embodiment of the present disclosure, the determining the data required to display the target page includes: searching whether a page analysis record includes an analysis record of the target page; if so, determining the data required to display the target page in accordance with the page analysis record; and if not, parsing the target page to determine the data required to display the target page.

In a possible embodiment of the present disclosure, the parsing the target page to determine the data required to display the target page includes: determining a class related to the target page, a resource related to the target page, a class on which the target page depends, and a resource on which the target page depends; and determining the class related to the target page, the resource related to the target page, the class on which the target page depends and the resource on which the target page depends as the data required to display the target page.

In a possible embodiment of the present disclosure, subsequent to parsing the target page to determine the data required to display the target page, the method further includes saving a parsing record of the target page into the page analysis record.

In a possible embodiment of the present disclosure, the method further includes: receiving a keyword from the UE; obtaining at least one page identifier in accordance with the keyword; and transmitting the at least one page identifier to the UE.

In a third aspect, the present disclosure provides in some embodiments a UE, including: a determination unit configured to determine a target page to be displayed; a transmission unit configured to transmit request information for requesting a data packet corresponding to the target page to a server, the request information including an identifier of the target page and a first identifier set, the first identifier set including identifiers of pages loaded by the UE in a second identifier set, and the second identifier set including identifiers of all pages in a software package to which the target page belongs; and a reception unit configured to receive a data packet corresponding to the target page from the server.

In a possible embodiment of the present disclosure, the UE further includes: a searching unit configured to determine whether the data packet corresponding to the target page is stored in a local cache; a reading unit configured to read the data packet corresponding to the target page from the local cache in the case that the data packet corresponding to the target page is stored in local cache. The transmission unit is further configured to transmit the request information to the server in the case that the data packet corresponding to the target page is not stored in local cache.

In a possible embodiment of the present disclosure, the request information further includes screen information about the UE, and the screen information about the UE includes one or more of a screen size of the UE, a screen resolution of the UE and the quantity of pixels in a unit area of a screen of the UE.

In a possible embodiment of the present disclosure, the UE further includes a processing unit configured to display the target page in accordance with the data packet corresponding to the target page.

In a possible embodiment of the present disclosure, the UE further includes a verification unit configured to verify whether the data packet corresponding to the target page is legal. The processing unit is further configured to display the target page in accordance with the data packet corresponding to the target page in the case that the data packet corresponding to the target page is legal.

In a possible embodiment of the present disclosure, the determination unit includes: an input module configured to receive a keyword inputted by a user; a transmission module configured to transmit the keyword to the server; a reception module configured to receive at least one page identifier from the server; a display module configured to display the at least one page identifier, the input module being further configured to receive an input of a target page identifier in the at least one page identifier from the user; and a processing module configured to determine a page corresponding to the target page identifier as the target page.

In a fourth aspect, the present disclosure provides in some embodiments a server, including: a reception unit configured to receive request information for requesting a data packet corresponding to a target page from a UE, the request information including an identifier of the target page and a first identifier set, the first identifier set including identifiers of pages loaded by the UE in a second identifier set, and the second identifier set including identifiers of all pages in a software package to which the target page belongs; a first determination unit configured to determine data required to display the target page; a second determination unit configured to obtain data loaded by the UE in accordance with the first identifier set; a processing unit configured to determine incremental data in accordance with the data required to display the target page and the data loaded by the UE; a packaging unit configured to generate the data packet corresponding to the target page in accordance with the incremental data; and a transmission unit configured to transmit the data packet corresponding to the target page to the UE.

In a possible embodiment of the present disclosure, the request information further includes screen information about the UE, and the screen information about the UE includes one or more of a screen size of the UE, a screen resolution of the UE, and the quantity of pixels in a unit area of a screen of the UE. The server further includes an extraction unit configured to extract data corresponding to the screen information from the incremental data, and the packaging unit is further configured to package the data corresponding to the screen information into the data packet corresponding to the target page.

In a possible embodiment of the present disclosure, the first determination unit includes: a searching module configured to search whether a page analysis record includes an analysis record of the target page; a reading module configured to determine the data required to display the target page in accordance with the page analysis record in the case that the page analysis record includes the analysis record of the target page; and a parsing module configured to parse the target page to determine the data required to display the target page in the case that the page analysis record does not include the analysis record of the target page.

In a possible embodiment of the present disclosure, the parsing module is further configured to: determine a class related to the target page, a resource related to the target page, a class on which the target page depends, and a resource on which the target page depends; and determine the class related to the target page, the resource related to the target page, the class on which the target page depends and the resource on which the target page depends as the data required to display the target page.

In a possible embodiment of the present disclosure, the server further includes a recording unit configured to save a parsing record of the target page into the page analysis record.

In a possible embodiment of the present disclosure, the reception unit is further configured to receive a keyword from the UE, the processing unit is further configured to obtain at least one page identifier in accordance with the keyword, and the transmission unit is further configured to transmit the at least one page identifier to the UE.

In a fifth aspect, the present disclosure provides in some embodiments a system for loading page data, including the UE in the third aspect and the server in the fourth aspect.

In a sixth aspect, the present disclosure provides in some embodiments a UE, including a memory and a processor. The memory is configured to store therein a computer program, and the processor is configured to call the computer program so as to execute the method in the first aspect.

In a seventh aspect, the present disclosure provides in some embodiments a server, including a memory and a processor. The memory is configured to store therein a computer program, and the processor is configured to call the computer program so as to execute the method in the second aspect.

In an eighth aspect, the present disclosure provides in some embodiments a computer-readable storage medium storing therein a computer program. The computer program is executed by a processor so as to implement the method in the first aspect or the second aspect.

### BRIEF DESCRIPTION OF THE DRAWINGS

Through reading the detailed description hereinafter, the other advantages and benefits will be apparent to a person skilled in the art. The drawings are merely used to show the preferred embodiments, but shall not be construed as limiting the present disclosure. In addition, in the drawings, same reference symbols represent same members.

FIG. 1 is a schematic view showing a system for loading page data according to one embodiment of the present disclosure;

FIG. 2 is a flow chart of a method for loading page data according to one embodiment of the present disclosure;

FIG. 3 is another flow chart of the method for loading page data according to one embodiment of the present disclosure;

FIG. 4 is a schematic view showing a scenario for the method for loading page data according to one embodiment of the present disclosure;

FIG. 5 is a schematic view showing a UE according to one embodiment of the present disclosure;

FIG. 6 is another schematic view showing the UE according to one embodiment of the present disclosure;

FIG. 7 is a schematic view showing a server according to one embodiment of the present disclosure;

FIG. 8 is another schematic view showing the server according to one embodiment of the present disclosure;

FIG. 9 is a schematic view showing a hardware structure of the UE according to one embodiment of the present disclosure; and

FIG. 10 is a schematic view showing a hardware structure of the server according to one embodiment of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Such words as “first” and “second” involved in the specification and the appended claims are merely used to differentiate different objects rather than to represent any specific order. For example, a first interface and a second interface are used to differentiate the interfaces rather than to describe a specific order of the interfaces.

Such expressions as “illustrative” and “for example” are merely used to show examples or explanations. Any illustrative embodiment or scheme in the present disclosure shall not be construed as being superior over the other embodiment or scheme. Definitely, these words intend to exhibit relevant concepts in a concrete manner. In addition, unless otherwise defined, “a plurality of” means two or more.

In order to prevent the user experience from being adversely affected, a software dynamic updating technology has been proposed in the related art, which mainly includes a mode based on a plug-in technology and a mode based on a page interaction logic implemented through an interpretive language. However, for the mode based on the plug-in technology, there is too much redundant data when updating a single page, so it is not suitable for instant page access. For the mode based on the page interaction logic implemented through the interpretive language, the software running efficiency may be deteriorated. Hence, there is an urgent need to reduce or prevent the generation of the redundant data in a data packet corresponding to a single page, thereby to dynamically load and display the page.

An object of the present disclosure is to provide a method, a device and a system for loading page data, so as to reduce or prevent the generation of the redundant data in the data packet corresponding to a single page, thereby to dynamically load and display the page.

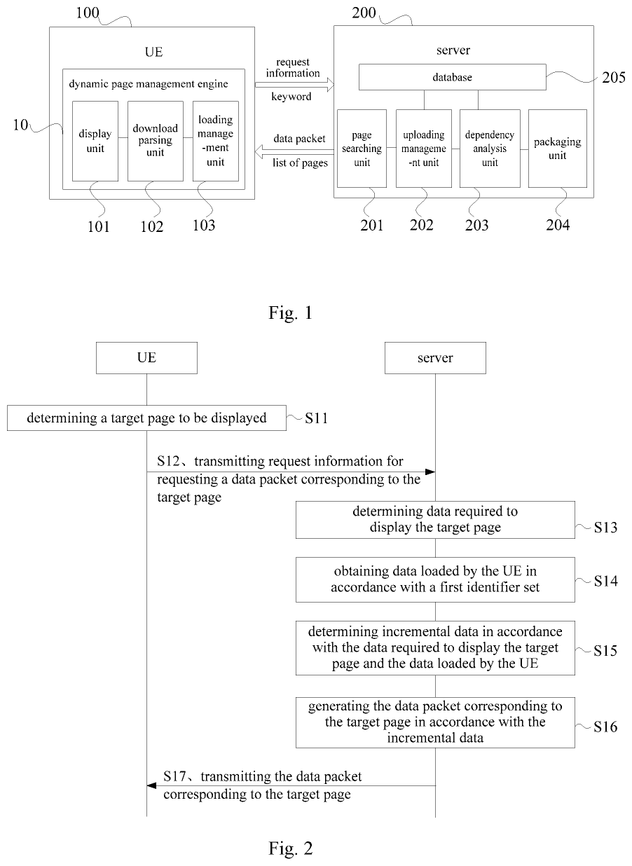

At first, a system for loading page data for implementing a method for loading page data will be described hereinafter. As shown in FIG. 1, the system in the embodiments includes a UE 100 and a server 200.

The UE 100 includes a packer Android Application Package (APK) for loading a page, and a core of the packer APK lies in a dynamic page management engine 10 which includes a display unit 101, a download parsing unit 102 and a loading management unit 103. The display unit 101 is configured to obtain a locally-used page or a preset page, or obtain a searched page or a page recommended by a cloud through an interface with the server, and display an identifier of the obtained page, so as to facilitate the user to select a page to be browsed according to the practical need. The download parsing unit 102 is configured to request a data packet corresponding to a target page from the server, and parse the data packet corresponding to the target page after the data packet corresponding to the target page has been downloaded locally, so as to obtain data (including a class and a resource required to display the target page) in the data packet corresponding to the target page. The loading management unit 103 is configured to load a class of a fragment obtained by the download parsing unit 102 into an activity page and start running, so as to display the target page. It should be appreciated that, the page loaded by the UE 100 has attributes of a group and a page identifier, and pages in a same group belong to one APK. Entity data (data packet) of the page loaded by the UE 100 includes independently-grouped data and partial data. The independently-grouped data refers to that a software data packet loaded by the UE 100 is an independently-grouped data packet including a plurality of pages and related dependency data, and the partial data refers to that the software data package loaded by the UE 100 merely includes data corresponding to one page.

The server 200 mainly includes a page searching unit 201, an uploading management unit 202, a dependency analysis unit 203, a packaging unit 204 and a database 205. The page searching unit 201 is configured to search the target page in accordance with a keyword, and return a list of possible target pages to the UE 100. The uploading management unit 202 is configured to parse the class of the fragment related to the APK when uploading the APK for implementing a page based on the fragment to the server, prompt an uploader to edit description information about the fragment (including whether the fragment is an independent page and whether the fragment is a main entry of a group), and upon the receipt of the description information, store the APK and related information in the database 205 for subsequent page search. The dependency analysis unit 203 is configured to parse the page and determine data required to display the page (including a class related to the page, a class resource related to the page, a system class of a non-Android framework layer on which the page depends, and a resource on which each class depends). The dependency analysis unit 203 is further configured to store a page parsing result into the database after parsing the page, so that a parsing record of the page is directly read from the database 205 subsequently. The packaging unit 204 is configured to obtain a minimum differential data packet of a currently-requested page in accordance with the data of the page loaded by the UE 100 and the data required to display the currently-requested page, package the differential data packet and transmit it to the UE 100.

Based on the above, the present disclosure provides in some embodiments a method for loading page data which, as shown in FIG. 2, includes the following steps S11 to S17.

S11: determining, by a UE, a target page to be displayed.

That is, the UE determines a software page to be browsed.

For example, the target page may be a page used by the UE, a preset page, a searched page obtained through an interface with a server, or a page in pages recommended by the cloud.

S12: transmitting, by the UE, request information for requesting a data packet corresponding to the target page to the server.

Correspondingly, the server receives the request information for requesting the data packet corresponding to the target page from the UE.

The request information includes an identifier of the target page and a first identifier set, the first identifier set includes identifiers of pages loaded by the UE in a second identifier set, and the second identifier set includes identifiers of all pages in a software package to which the target page belongs.

Merely the data corresponding to the page in a same APK as the target page may be used to display the target page, and the data corresponding to the pages in the other APK may not be used to display the target page, even with a same file name, due to different programming languages or programming habits. Hence, in a possible embodiment of the present disclosure, in S12, it is able to merely obtain the pages loaded by the UE in the APK to which the target page belongs.

For example, when an APK to which the target page belongs includes a page A, a page B, a page C and a page D, the page A is the target page, and identifiers of the page A, the page B, the page C and the page D are an identifier A, an identifier B, an identifier C and an identifier D, and the pages loaded by the UE include the page B, the page C and a page E, a set including identifiers of all pages in the software package is [identifier A, identifier B, identifier C, identifier D], so the second identifier set is [identifier A, identifier B, identifier C, identifier D]. A set including identifiers of the pages loaded by the UE in the second identifier set is [identifier B, identifier C], so the first identifier set is [identifier B, identifier C].

In a possible embodiment of the present disclosure, the identifier of the page is used to uniquely identify a page, and it specifically includes one or more of an Identity document (ID), a version identifier, a loading time, and a Hash code of the page.

It should be appreciated that, in the embodiments of the present disclosure, not only the identifiers of two different pages are different, but also the identifiers of different versions of one page are different, that is, after one page has been updated, the identifier of the page may also change.

S13: determining, by the server, the data required to display the target page.

In a possible embodiment of the present disclosure, the data required to display the target page includes a class related to the target page, a resource related to the target page, a system class of a non-Android framework layer on which the page depends, and a resource related to each class. The resource related to the target page includes a dex file, an XML file, an image and a character of the target page.

For example, the class related to the target page includes a class 1 and a class 2, the resource related to the target page includes a resource 1 and a resource 2, the class 1 depends on the class 3, the class 3 depends on the class 4, and the resource 1 depends on the resource 3. Hence, the data required to display the target page includes the resource 1, the resource 2, the resource 3, the class 1, the class 2, the class 3 and the class 4.

S14: obtaining, by the server, data loaded by the UE in accordance with the first identifier set.

Specifically, the data of the page loaded by the UE is the data loaded by the UE when displaying the loaded page. For example, the first identifier set includes the identifiers of the page B and the page C, the resource required to display page B includes the resource 2, the class required to display the page B includes the class 3, the resource required to display the page C includes the resource 2 and the resource 3, and the class required to display the page B includes the class 1. At this time, the data of the page loaded by the UE includes the resource 2, the resource 3, the class 1 and the class 3.

S15: determining, by the server, incremental data in accordance with the data required to display the target page and the data loaded by the UE.

In a possible embodiment of the present disclosure, the data required to display the target page and the data loaded by the UE are subjected to differential calculation, so as to determine the incremental data.

In the embodiments of the present disclosure, the data required to display the target page includes the resource 1, the resource 2, the resource 3, the class 1, the class 2, the class 3 and the class 4, and the data loaded by the UE includes the resource 2, the resource 3, the class 1 and the class 3. Hence, an incremental resource includes the resource 1, and an incremental class includes the class 2 and the class 4.

S16: generating, by the server, the data packet corresponding to the target page in accordance with the incremental data.

In the embodiments of the present disclosure, a method for generating the data packet in S16 will not be particularly defined herein, and the data packet may be generated using any packaging mode in accordance with a transmission requirement and a parsing requirement on the data packet.

S17: transmitting, by the server, the data packet corresponding to the target page to the UE.

Correspondingly, the UE receives a data packet corresponding to the target page from the server.

According to the method for loading page data in the embodiments of the present disclosure, after the UE has determined the target page to be displayed, it transmits the request information for requesting the data packet corresponding to the target page to the server. The request information includes the identifier of the target page and the first identifier set, the first identifier set includes the identifiers of the pages loaded by the UE in the second identifier set; and the second identifier set includes the identifiers of all pages in the software package to which the target page belongs. The server obtains the data loaded by the UE in accordance with the first identifier set, filters out the resource and class loaded by the UE in the data required to display the target page in accordance with the data required to display the target page and the data loaded by the UE, determines the incremental data, generates the data packet corresponding to the target page in accordance with the incremental data, and transmits the data packet to the UE. Through filtering out the data loaded by the UE in the data required to display the target page, it is able to reduce redundant data in the data packet corresponding to the target page, thereby to dynamically load and display the target page.

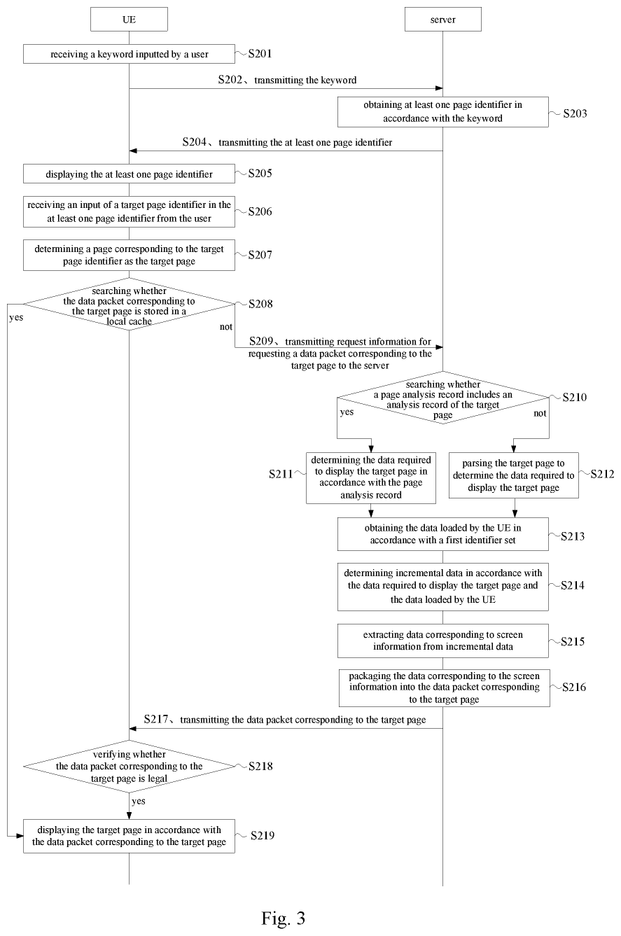

In order to describe the method in FIG. 2 in a refined and expanded manner, the present disclosure further provides in some embodiments another method for loading page data which, as shown in FIG. 3, includes the following steps S201 to S219.

S201: receiving, by a UE, a keyword inputted by a user.

Specifically, the keyword may be one or more of a name of a page to be browsed, an introduction about the page to be browsed, functional description about the page to be browsed, and a character in the page to be browsed.

S202: transmitting, by the UE, the keyword to a server.

Correspondingly, the server receives the keyword from the UE.

S203: obtaining, by the server, at least one page identifier in accordance with the keyword.

Specifically, the server obtains at least one or more pages to be browsed in accordance with the keyword.

S204: transmitting, by the server, the at least one page identifier to the UE.

Correspondingly, the UE receives the at least one page identifier from the server.

S205: displaying, by the UE, the at least one page identifier.

In a possible embodiment of the present disclosure, in addition to that mentioned in S201 to S204, the UE may also obtain an identifier of a page used by the UE, or an identifier of a preset page, or an identifier of a page recommended by the cloud.

S206: receiving, by the UE, an input of a target page identifier in the at least one page identifier from the user.

Specifically, the input of the target page identifier by the user may be a click operation on the target page identifier by the user, a voice instruction inputted by the user, or a specific gesture inputted by the user. In addition, in some embodiments of the present disclosure, the specific gesture may be any one of a single click gesture, a slide gesture, a pressure recognition gesture, a long press gesture, an area change gesture, a double press gesture and a double click gesture.

S207: determining, by the UE, a page corresponding to the target page identifier as the target page.

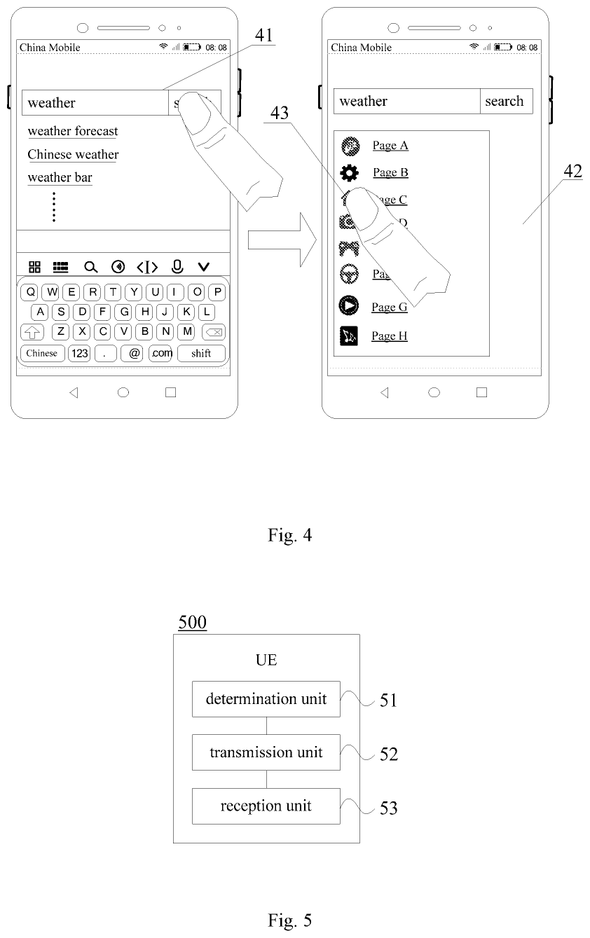

For example, FIG. 4 shows an application scenario of S201 to S207. At first, the user inputs a keyword “weather” in a search box 41 on a search interface. The UE transmits the keyword to the server, receives at least one page identifier from the server, and displays the at least one page identifier on a display interface 42 in the form of a page identifier list. Finally, the UE receives a touch click operation made by the user on the target page identifier 43, and determines a page corresponding to the target page identifier 43 as the target page.

S208: searching, by the UE, whether the data packet corresponding to the target page is stored in a local cache.

Specifically, the identifier of the target page is obtained at first, and then the data packet corresponding to the target page is searched in the local cache in accordance with the identifier of the target page.

It should be appreciated that, in the embodiments of the present disclosure, when the data packet corresponding to the target page is stored in the local cache, it means that a latest-version data packet corresponding to the target page is stored in the local cache. When the data packet corresponding to the target page stored in the local cache is not the latest-version data packet, the data packet corresponding to the target page is not stored in the local cache.

In S208, when the data packet corresponding to the target page is stored in the local cache, the data packet corresponding to the target page is directly loaded, and the process proceeds to S219. When the data packet is not stored in the local cache, the following step S209 is performed.

S209: transmitting, by the UE, request information for requesting the data packet corresponding to the target page to the server.

Correspondingly, the server receives the request information for requesting the data packet corresponding to the target page from the UE.

The request information includes an identifier of the target page, a first identifier set, and screen information about the UE.

The first identifier set includes identifiers of the pages loaded by the UE in a second identifier set, and the second identifier set includes identifiers of all pages in a software package to which the target page belongs.

The screen information about the UE includes one or more of a screen size of the UE, a screen resolution of the UE, and the quantity of pixels in a unit area of a screen of the UE.

In a possible embodiment of the present disclosure, the quantity of pixels in a unit area of the screen of the UE may be Dots Per Inch (DPI) of the screen of the UE.

S210: searching, by the server, whether a page analysis record includes an analysis record of the target page.

In S210, when the page analysis record includes the analysis record of the target page, the following step S211 is performed, and when the page analysis record does not include the analysis record of the target page, the following step S212 is performed.

S211: determining, by the server, the data required to display the target page in accordance with the page analysis record.

S212: parsing, by the server, the target page to determine the data required to display the target page.

In a possible embodiment of the present disclosure, S212 (parsing the target page to determine the data required to display the target page) includes: determining a class related to the target page, a resource related to the target page, a class on which the target page depends, and a resource on which the target page depends; and determining the resource related to the target page and the resource on which the target page depends as resources required to display the target page, and determining the class related to the target page and the class on which the target page depends as classes required to display the target page.

S213: obtaining, by the server, the data loaded by the UE in accordance with the first identifier set.

S214: determining, by the server, incremental data in accordance with the data required to display the target page and the data loaded by the UE.

S215: extracting, by the server, data corresponding to the screen information from the incremental data.

That is, the server extracts the data adapted to the screen information about the UE from the incremental data.

S216: packaging, by the server, the data corresponding to the screen information into the data packet corresponding to the target page.

In order to adapt to screens of the UE with different resolutions and different sizes, the data packet corresponding to the target page includes data corresponding to various screen resolutions and various screen sizes. However, the screen of the UE merely needs to obtain data corresponding to its resolution and screen size, and the remaining data is redundant data. In the embodiments of the present disclosure, subsequent to obtaining the incremental data, t the data corresponding to the screen information is extracted from the incremental data, and merely the data corresponding to the screen information is packaged into the data packet corresponding to the target page. In this regard, it is able to further reduce the redundant data in the data packet corresponding to the target page.

S217: transmitting, by the server, the data packet corresponding to the target page to the UE.

Correspondingly, the UE receives the data packet corresponding to the target page from the server.

S218: verifying, by the server, whether the data packet corresponding to the target page is legal.

Specifically, the verifying, by the UE, whether the data packet corresponding to the target page is legal includes at least one of: performing data integrity verification on the data packet corresponding to the target page; and performing correctness verification on the data packet corresponding to the target page.

The performing the data integrity verification on the data packet corresponding to the target page includes performing the data integrity verification on the data packet corresponding to the target page through a Message-Digest Algorithm (MD5). The performing the correctness verification on the data packet corresponding to the target page includes analyzing a header file of the data packet corresponding to the target page to determine correctness of the data packet corresponding to the target page.

In S218, when the data packet corresponding to the target page is legal, S219 is performed, and when the data packet corresponding to the target page is not legal, the process returns to step S209 to transmit the request information to the server again, thereby to obtain the data packet corresponding to the target page again.

S219: displaying, by the UE, the target page in accordance with the data packet corresponding to the target page.

In a possible embodiment of the present disclosure, the UE displays the target page in accordance with the data packet corresponding to the target page through the following step a to step c.

Step a: analyzing the data packet corresponding to the target page, and obtaining the data required to display the target page.

Step b: determining, through reflection, a fragment class of the target page in accordance with a dex file in the data required to display the target page.

Step c: starting a fragment page corresponding to the fragment class of the target page on a current activity page in accordance with the data required to display the target page.

The method for loading page data in the embodiments of the present disclosure has a similar technical effect as the method for loading page data in FIG. 2, which will thus not be particularly defined herein.

Based on a same inventive concept, the present disclosure further provides in some embodiments a UE for executing the steps executed by the UE in the method embodiments and a server for executing the steps executed by the server in the method embodiments. For clarification, the details in the above-mentioned method embodiments will not repeated herein. It should be appreciated that, the UE and the server may implement all the contents in the above-mentioned method embodiments.

The present disclosure provides in some embodiments a UE 500 which, as shown in FIG. 5, includes: a determination unit 51 configured to determine a target page to be displayed; a transmission unit 52 configured to transmit request information for requesting a data packet corresponding to the target page to a server, the request information including an identifier of the target page and a first identifier set, the first identifier set including identifiers of pages loaded by the UE in a second identifier set, and the second identifier set including identifiers of all pages in a software package to which the target page belongs; and a reception unit 53 configured to receive a data packet corresponding to the target page from the server.

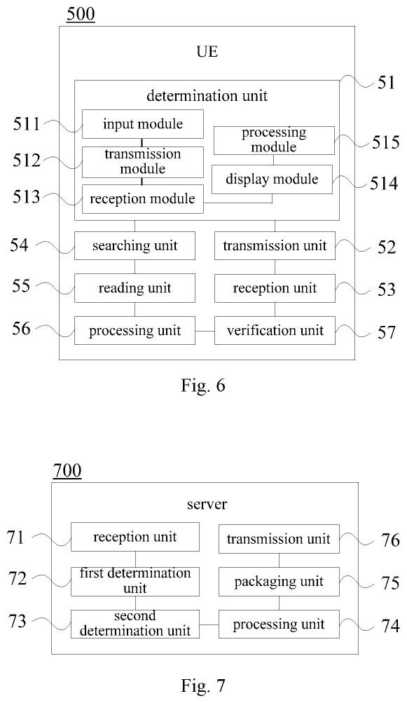

In a possible embodiment of the present disclosure, as shown in FIG. 6, the UE 500 further includes: a searching unit 54 configured to determine whether the data packet corresponding to the target page is stored in a local cache; a reading unit 55 configured to read the data packet corresponding to the target page from the local cache in the case that the data packet corresponding to the target page is stored in local cache. The transmission unit 52 is further configured to transmit the request information to the server in the case that the data packet corresponding to the target page is not stored in local cache.

In a possible embodiment of the present disclosure, the request information further includes screen information about the UE, and the screen information about the UE includes one or more of a screen size of the UE, a screen resolution of the UE and the quantity of pixels in a unit area of a screen of the UE.

In a possible embodiment of the present disclosure, as shown in FIG. 6, the UE further includes a processing unit 56 configured to display the target page in accordance with the data packet corresponding to the target page.

In a possible embodiment of the present disclosure, as shown in FIG. 6, the UE 500 further includes a verification unit 57 configured to verify whether the data packet corresponding to the target page is legal. The processing unit 56 is further configured to display the target page in accordance with the data packet corresponding to the target page in the case that the data packet corresponding to the target page is legal.

In a possible embodiment of the present disclosure, as shown in FIG. 6, the determination unit 51 includes: an input module 511 configured to receive a keyword inputted by a user; a transmission module 512 configured to transmit the keyword to the server; a reception module 513 configured to receive at least one page identifier from the server; a display module 514 configured to display the at least one page identifier, the input module 511 being further configured to receive an input of a target page identifier in the at least one page identifier from the user; and a processing module 515 configured to determine a page corresponding to the target page identifier as the target page.

The present disclosure further provides in some embodiments a server 700 which, as shown in FIG. 7, includes: a reception unit 71 configured to receive request information for requesting a data packet corresponding to a target page from a UE, the request information including an identifier of the target page and a first identifier set, the first identifier set including identifiers of pages loaded by the UE in a second identifier set, and the second identifier set including identifiers of all pages in a software package to which the target page belongs; a first determination unit 72 configured to determine data required to display the target page; a second determination unit 73 configured to obtain data loaded by the UE in accordance with the first identifier set; a processing unit 74 configured to determine incremental data in accordance with the data required to display the target page and the data loaded by the UE; a packaging unit 75 configured to generate the data packet corresponding to the target page in accordance with the incremental data; and a transmission unit 76 configured to transmit the data packet corresponding to the target page to the UE.

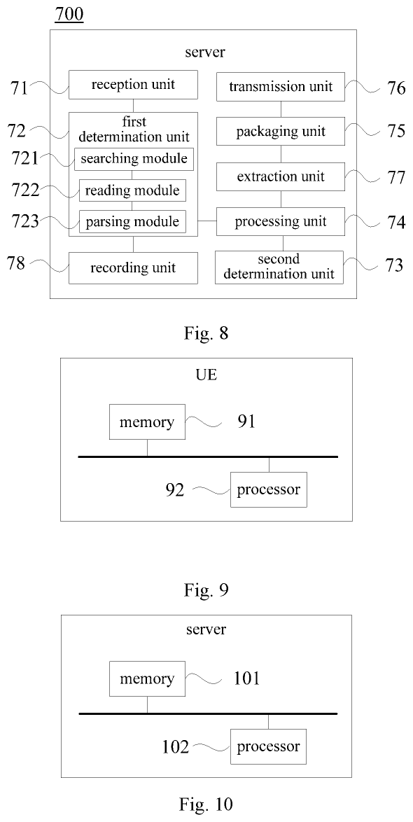

In a possible embodiment of the present disclosure, the request information further includes screen information about the UE, and the screen information about the UE includes one or more of a screen size of the UE, a screen resolution of the UE, and the quantity of pixels in a unit area of a screen of the UE. As shown in FIG. 8, the server 700 further includes an extraction unit 77 configured to extract data corresponding to the screen information from the incremental data, and the packaging unit 75 is further configured to package the data corresponding to the screen information into the data packet corresponding to the target page.

In a possible embodiment of the present disclosure, as shown in FIG. 8, the first determination unit 72 includes: a searching module 721 configured to search whether a page analysis record includes an analysis record of the target page; a reading module 722 configured to determine the data required to display the target page in accordance with the page analysis record in the case that the page analysis record includes the analysis record of the target page; and a parsing module 723 configured to parse the target page to determine the data required to display the target page in the case that the page analysis record does not include the analysis record of the target page.

In a possible embodiment of the present disclosure, the parsing module 723 is further configured to: determine a class related to the target page, a resource related to the target page, a class on which the target page depends, and a resource on which the target page depends; and determine the class related to the target page, the resource related to the target page, the class on which the target page depends and the resource on which the target page depends as the data required to display the target page.

In a possible embodiment of the present disclosure, as shown in FIG. 8, the server 700 further includes a recording unit 78 configured to save a parsing record of the target page into the page analysis record.

In a possible embodiment of the present disclosure, the reception unit 71 is further configured to receive a keyword from the UE, the processing unit 74 is further configured to obtain at least one page identifier in accordance with the keyword, and the transmission unit 76 is further configured to transmit the at least one page identifier to the UE.

The UE and the server in the embodiments of the present disclosure are used to implement the above-mentioned method for loading page data with a similar principle and a similar technical effect, which will thus not be particularly defined herein.

Based on a same inventive concept, the present disclosure further provides in some embodiment a UE which, as shown in FIG. 9, includes a memory 91 and a processor 92. The memory 91 is configured to store therein a computer program, and the processor 92 is configured to call the computer program so as to execute the steps executed by the UE in the above method.

For example, the UE in the embodiments of the present disclosure may be a mobile phone, a portable android device (PAD), a smart watch or a vehicle-mounted device.

Based on a same inventive concept, the present disclosure further provides in some embodiment a server which, as shown in FIG. 10, includes a memory 101 and a processor 102. The memory 101 is configured to store therein a computer program, and the processor 102 is configured to call the computer program so as to execute the steps executed by the server in the above method.

The present disclosure further provides in some embodiments a computer-readable storage medium storing therein a computer program. The computer program is executed by a processor so as to implement the above-mentioned method for loading page data.

It should be appreciated that, the present disclosure may be provided as a method, a system or a computer program product, so the present disclosure may be in the form of full hardware embodiments, full software embodiments, or combinations thereof. In addition, the present disclosure may be in the form of a computer program product implemented on one or more computer-readable storage mediums including computer-readable program codes

The processor may be a Central Processing Unit (CPU) or any other general purpose processor, a Digital Signal Processor (DSP), an Application Specific Integrated Circuit (ASIC), a Field-Programmable Gate Array (FPGA) or any other programmable logic element, a discrete gate or transistor logic device, or a discrete hardware assembly. The general purpose processor may be a microprocessor or any other conventional processor.

The memory may include an impermanent memory, a Random Access Memory (RAM) and/or a nonvolatile memory in the computer-readable storage medium, e.g., a Read Only Memory (ROM) or a flash RAM. The memory may be an example of the computer-readable storage medium.

The computer-readable storage medium may include volatile or nonvolatile, mobile or immobile storage medium capable of storing therein information using any method or technique. The information may be a computer-readable instruction, a data structure, a program or any other data. The computer-readable storage medium may include, but not limited to, an RAM (e.g., phase change random access memory (Phase Change Random Access Memory, PRAM), SRAM or DRAM, an ROM (e.g., an EEPROM, a flash memory, a CD-ROM or a digital video disk (Digital Video Disk, DVD)), a magnetic storage device (e.g., a cassette magnetic tape or a magnetic disk), or any other non-transmission medium capable of storing therein information which can be accessed by a computing device. As defined in the present disclosure, the computer-readable storage medium may not include any transitory media, e.g., modulated data signal or carrier.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A method for loading page data for a User Equipment (UE), comprising:
determining a target page to be displayed;
transmitting request information for requesting a data packet corresponding to the target page to a server, the request information comprising an identifier of the target page and a first identifier set, the first identifier set comprising identifiers of pages loaded by the UE in a second identifier set, and the second identifier set comprising identifiers of all pages in a software package to which the target page belongs; and
receiving the data packet corresponding to the target page from the server.

2. The method according to claim 1, wherein subsequent to determining the target page to be displayed and prior to transmitting the request information for requesting the data packet corresponding to the target page to the server, the method further comprises: searching whether the data packet corresponding to the target page is stored in a local cache; if so, reading the data packet corresponding to the target page from the local cache; and if not, transmitting the request information to the server.

3. The method according to claim 1, wherein the request information further comprises screen information about the UE, and the screen information about the UE comprises one or more of a screen size of the UE, a screen resolution of the UE and the quantity of pixels in a unit area of a screen of the UE.

4. The method according to claim 1, further comprising displaying the target page in accordance with the data packet corresponding to the target page.

5. The method according to claim 4, wherein prior to displaying the target page in accordance with the data packet corresponding to the target page, the method further comprises: verifying whether the data packet corresponding to the target page is legal; and displaying the target page in accordance with the data packet corresponding to the target page in the case that the data packet corresponding to the target page is legal.

6. The method according to claim 1, wherein the determining the target page to be displayed comprises: receiving a keyword inputted by a user; transmitting the keyword to the server; receiving at least one page identifier from the server; displaying the at least one page identifier; receiving an input of a target page identifier in the at least one page identifier from a user; and determining a page corresponding to the target page identifier as the target page.

7. A method for loading page data for a server, comprising:
receiving request information for requesting a data packet corresponding to a target page from a UE, the request information comprising an identifier of the target page and a first identifier set, the first identifier set comprising identifiers of pages loaded by the UE in a second identifier set, and the second identifier set comprising identifiers of all pages in a software package to which the target page belongs; determining data required to display the target page;
obtaining data loaded by the UE in accordance with the first identifier set;
determining incremental data in accordance with the data required to display the target page and the data loaded by the UE;
generating the data packet corresponding to the target page in accordance with the incremental data; and
transmitting the data packet corresponding to the target page to the UE.

8. The method according to claim 7, wherein the request information further comprises screen information about the UE, and the screen information about the UE comprises one or more of a screen size of the UE, a screen resolution of the UE and the quantity of pixels in a unit area of a screen of the UE, wherein the generating the data packet corresponding to the target page in accordance with the incremental data comprises: extracting data corresponding to the screen information from an incremental class and an incremental resource; and packaging the data corresponding to the screen information into the data packet corresponding to the target page.

9. The method according to claim 7, wherein the determining the data required to display the target page comprises: searching whether a page analysis record comprises an analysis record of the target page; if so, determining the data required to display the target page in accordance with the page analysis record; and if not, parsing the target page to determine the data required to display the target page.

10. The method according to claim 9, wherein the parsing the target page to determine the data required to display the target page comprises: determining a class related to the target page, a resource related to the target page, a class on which the target page depends, and a resource on which the target page depends; and determining the class related to the target page, the resource related to the target page, the class on which the target page depends and the resource on which the target page depends as the data required to display the target page.

11. The method according to claim 9, wherein subsequent to parsing the target page to determine the data required to display the target page, the method further comprises saving a parsing record of the target page into the page analysis record.

12. The method according to claim 7, further comprising: receiving a keyword from the UE; obtaining at least one page identifier in accordance with the keyword; and transmitting the at least one page identifier to the UE.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. A system for loading page data, comprising a UE and a server, wherein the UE comprises:
a determination unit configured to determine a target page to be displayed;
a transmission unit configured to transmit request information for requesting a data packet corresponding to the target page to the server, the request information comprising an identifier of the target page and a first identifier set, the first identifier set comprising identifiers of pages loaded by the UE in a second identifier set, and the second identifier set comprising identifiers of all pages in a software package to which the target page belongs; and
a reception unit configured to receive a data packet corresponding to the target page from the server,
wherein the server comprises:
a reception unit configured to receive request information for requesting a data packet corresponding to a target page from the UE, the request information comprising an identifier of the target page and a first identifier set, the first identifier set comprising identifiers of pages loaded by the UE in a second identifier set, and the second identifier set comprising identifiers of all pages in a software package to which the target page belongs;
a first determination unit configured to determine data required to display the target page;
a second determination unit configured to obtain data loaded by the UE in accordance with the first identifier set;
a processing unit configured to determine incremental data in accordance with the data required to display the target page and the data loaded by the UE;
a packaging unit configured to generate the data packet corresponding to the target page in accordance with the incremental data; and
a transmission unit configured to transmit the data packet corresponding to the target page to the UE.

26. A UE, comprising a memory and a processor, wherein the memory is configured to store therein a computer program, and the processor is configured to call the computer program so as to implement the method according to claim 1.

27. A server, comprising a memory and a processor, wherein the memory is configured to store therein a computer program, and the processor is configured to call the computer program so as to implement the method according to any one of claim 7.

28. (canceled)

29. The UE according to claim 26, wherein subsequent to determining the target page to be displayed and prior to transmitting the request information for requesting the data packet corresponding to the target page to the server, the processor is further configured to: search whether the data packet corresponding to the target page is stored in a local cache; if so, read the data packet corresponding to the target page from the local cache; and if not, transmit the request information to the server.

30. The UE according to claim 26, wherein the request information further comprises screen information about the UE, and the screen information about the UE comprises one or more of a screen size of the UE, a screen resolution of the UE and the quantity of pixels in a unit area of a screen of the UE.

31. The UE according to claim 26, wherein the processor is further configured to display the target page in accordance with the data packet corresponding to the target page.

32. The UE according to claim 31, wherein prior to displaying the target page in accordance with the data packet corresponding to the target page, the processor is further configured to: verify whether the data packet corresponding to the target page is legal; and display the target page in accordance with the data packet corresponding to the target page in the case that the data packet corresponding to the target page is legal.

33. The UE according to claim 26, wherein the processor is further configured to: receive a keyword inputted by a user; transmit the keyword to the server; receive at least one page identifier from the server; display the at least one page identifier; receive an input of a target page identifier in the at least one page identifier from a user; and determine a page corresponding to the target page identifier as the target page.
